(19) United States
(12) Patent Application Publication
(10) Pub. No.: US 2015/0363462 A1
(43) Pub. Date: Dec. 17, 2015

(54) METHODS, SYSTEMS, AND COMPUTER PROGRAM PRODUCTS FOR TRANSLATING A CHANGE IN A TRANSIENT DATA OBJECT OF AN OBJECT ORIENTED COMPUTER PROGRAM INTO A COMMAND FOR A NAVIGATIONAL DATABASE SYSTEM

(71) Applicant: CA, Inc., Islandia, NY (US)

(72) Inventors: Michal Cizek, Praha 2 (CZ); Lukas Patera, Kladno (CZ); Petr Vlasek, Laskova 1796 (CZ)

(21) Appl. No.: 14/306,918

(22) Filed: Jun. 17, 2014

(51) Int. Cl. G06F 17/30

(52) U.S. Cl. CPC G06F 17/30427; G06F 17/30917

(57) ABSTRACT

A method includes performing operations as follows on a processor: detecting a change in a transient data object of an object oriented program during program runtime, translating the change into a command for a navigational database management system, and executing the command on the navigational database management system.

### BACKGROUND

The present disclosure relates to computing systems, and, in particular, to computing systems that access a navigational database from an object-oriented programming language.

A navigational database is a type of database in which records or objects are found primarily by following references from other objects. A navigational database may use a hierarchical database model or a network database model. The hierarchical database model structures data as a tree of records, with each record having one parent record and many children, while the network model allows each record to have multiple parent and child records, forming a generalized graph structure. As shown in FIG. 1, there are two approaches for accessing a navigational database from an object-oriented programming language. A first approach is to embed an object-oriented computer program 105 with a native data definition and manipulation language (DDL/DML) 110 to access the navigational database 115. A second approach is to apply a relational database conversion 125 to an object oriented computer program 120 and then apply a subsequent navigational database conversion 130 to transform from from the relational database scheme to a navigational database scheme to access the navigational database 135. These two approaches, however, may have certain drawbacks. With regard to the embedded native DDL/DML approach, the software developer designs and maintains two isolated data models—one for transient program runtime and another for more permanent data storage—and is responsible for synchronization between the two models. A software developer may not be able to make full use of the object oriented host language and may be constrained to use of the embedded DDL/DML. The software developer also needs to have some familiarity with programming in native DDL/DML. A precompiler is used for the host object oriented language. With regard to the approach of converting to a relational database schema and then converting to a navigational database schema, two conversions are required in which structural differences between the object model and the relational database model and structural differences between the relational database model and the navigational database model may need to be resolved,

### SUMMARY

In some embodiments of the inventive subject matter, a method comprises performing operations as follows on a processor: detecting a change in a transient data object of an object oriented program during program runtime, translating the change into a command for a navigational database management system, and executing the command on the navigational database management system.

In other embodiments, a system comprises a processor and a memory coupled to the processor, which comprises computer readable program code embodied in the memory. When the computer readable program code is executed by the processor it causes the processor to perform operations comprising detecting a change in a transient data object of an object oriented program during program runtime, translating the change into a command for a navigational database management system, and executing the command on the navigational database management system.

In further embodiments, a computer program product comprises a tangible computer readable storage medium, which comprises computer readable program code embodied in the medium that when executed by a processor causes the processor to perform operations comprising: detecting a change in a transient data object of an object oriented program during program runtime, translating the change into a command for a navigational database management system, and executing the command on the navigational database management system.

Other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of exemplary embodiments will be more readily understood from the following detailed description of specific embodiments thereof when read in conjunction with the accompanying drawings, in which:

FIG. 1 is a block diagram that illustrates approaches for accessing a navigational database from an object-oriented programming language.

FIG. 2 is a block diagram that illustrates methods, systems, and computer program products for translating a change in a transient data object of an object oriented computer program into a command for a navigational database system according to some embodiments of the inventive subject matter.

FIG. 3 illustrates a data processing system that may be used to implement the object oriented program, mapping engine, and navigational database management system of FIG. 2 according to some embodiments of the inventive subject matter.

FIG. 4 is a block diagram that illustrates a software/hardware architecture for translating a change in a transient data object of an object oriented computer program into a command for a navigational database system according to some embodiments of the inventive subject matter.

FIG. 5 illustrates relationships between entities represented in an object oriented model according to some embodiments of the inventive subject matter.

FIG. 6 illustrates relationships between entities represented in navigational database model according to some embodiments of the inventive subject matter.

FIG. 7 is a flowchart that illustrates operations for translating a change in a transient data object of an object oriented computer program into a command for a navigational database system according to some embodiments of the inventive subject matter.

FIGS. 8-11 are pseudo code examples that illustrate operations of the mapping engine of FIGS. 2 and 4 according to some embodiments of the inventive subject matter.

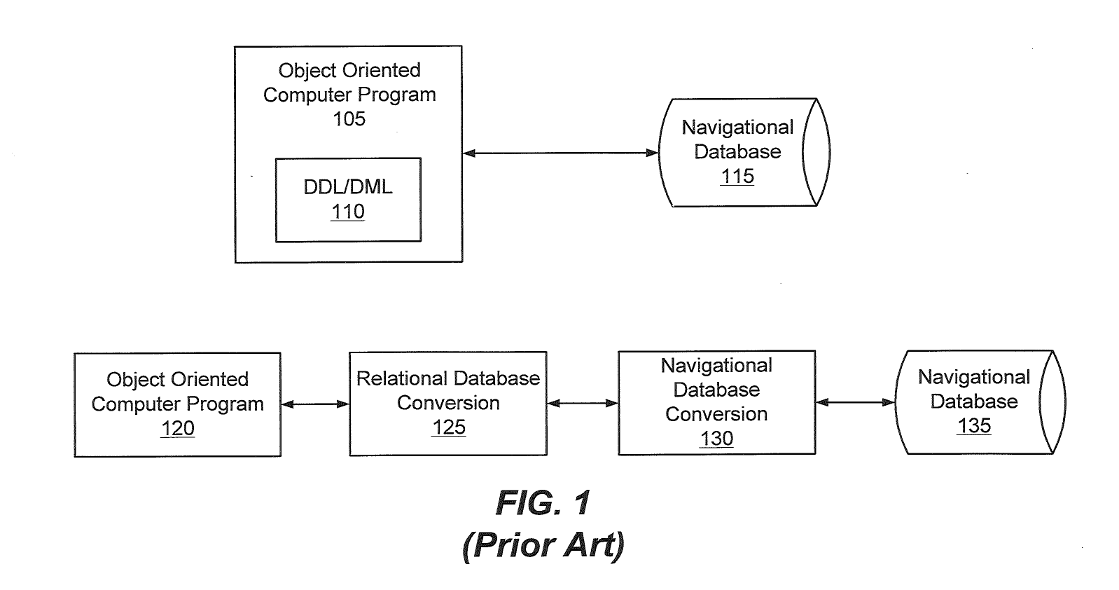

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave, Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

As used herein, the term “data processing facility” includes, but it not limited to, a hardware element, firmware component, and/or software component. A data processing system may be configured with one or more data processing facilities.

As used herein “data” means raw, unorganized facts that need to be processed. Data can be something simple and seemingly random and useless until it is organized. When data is processed, organized, structured or presented in a given context so as to make it useful, it is called “information.”

Some embodiments of the inventive subject matter stem from a realization that there are similarities between an objected oriented data model and a navigational database model that may be exploited through use of a mapping engine. The mapping engine may translate the change detected in a transient data object of an object oriented computer program during runtime into a command for a navigational database management system without the need of using an embedded native database language or using a double conversion approach from an object oriented model, to a relational database model, and finally to a navigational database model. The mapping engine may allow a software developer to use a navigational database transparently when programming in an object oriented programming language.

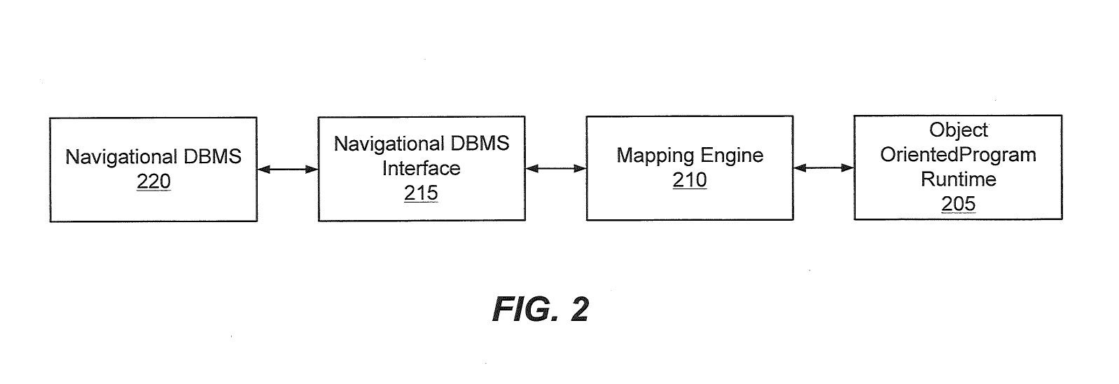

FIG. 2 is a block diagram that illustrates methods, systems, and computer program products for translating a change in a transient data object of an object oriented computer program into a command for a navigational database system according to some embodiments of the inventive subject matter.

The object oriented program at runtime 205 uses object instances, i.e., instantiations of classes, to model data. The mapping engine 210 automatically translates changes in the transient data objects used to model data into commands for a navigational database management system interface 215. These changes in the transient data objects may include, but are not limited to, creation of a new data object instance, destruction of an existing data object instance, and modification of attribute(s) of existing of an data object. The navigational database management system interface 215 is used to provide an interface for the mapping engine 210 to use when storing and retrieving data in the navigational database management system 220. When the mapping engine 210 creates a new data object instance, for example, the mapping engine 210 may create the new data object instance based on data retrieved from the navigational database management system 220. In accordance with various embodiments of the inventive subject matter, the navigational database management system 220 may be a network model navigational database management system or a hierarchical database model navigational database management system. The mapping engine 210 may allow a software developer to design object oriented code that can use the navigational database management system 220 without knowledge of the details of how the navigational database management system 220 can be used directly of even knowledge of the navigational database management system 220 type or its native language. The software developer can generate code that uses various concepts and features available in an object oriented programming language, such as calling methods on objects, annotations, definitions stored in XML files and used during program runtime, etc.

Although FIG. 2 illustrates an exemplary system for translating a change in a transient data object of an object oriented computer program into a command for a navigational database system, it will be understood that embodiments of the present invention are not limited to such configurations, but are intended to encompass any configuration capable of carrying out the operations described herein.

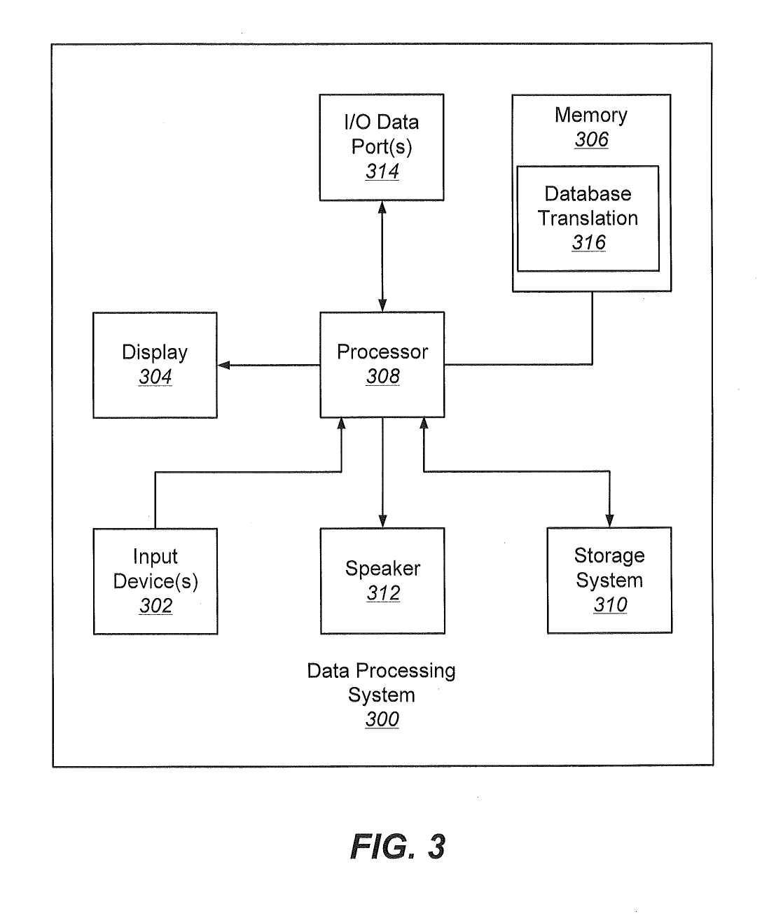

Referring now to FIG. 3, a data processing system 300 that may be used to implement the object oriented program 205, mapping engine 210, and navigational database management system interface 215 of FIG. 2, in accordance with some embodiments of the inventive subject matter, comprises input device(s) 302, such as a keyboard or keypad, a display 304, and a memory 2306 that communicate with a processor 308. The data processing system 300 may further include a storage system 310, a speaker 312, and an input/output (I/O) data port(s) 314 that also communicate with the processor 308. The storage system 310 may include removable and/or fixed media, such as floppy disks, ZIP drives, hard disks, or the like, as well as virtual storage, such as a RAMDISK. The I/O data port(s) 314 may be used to transfer information between the data processing system 300 and another computer system or a network (e.g., the Internet). These components may be conventional components, such as those used in many conventional computing devices, and their functionality, with respect to conventional operations, is generally known to those skilled in the art. The memory 306 may be configured with a database translation module 316 that may be configured to translate a change in a transient data object of an object oriented computer program into a command for a navigational database system according to some embodiments of the inventive subject matter.

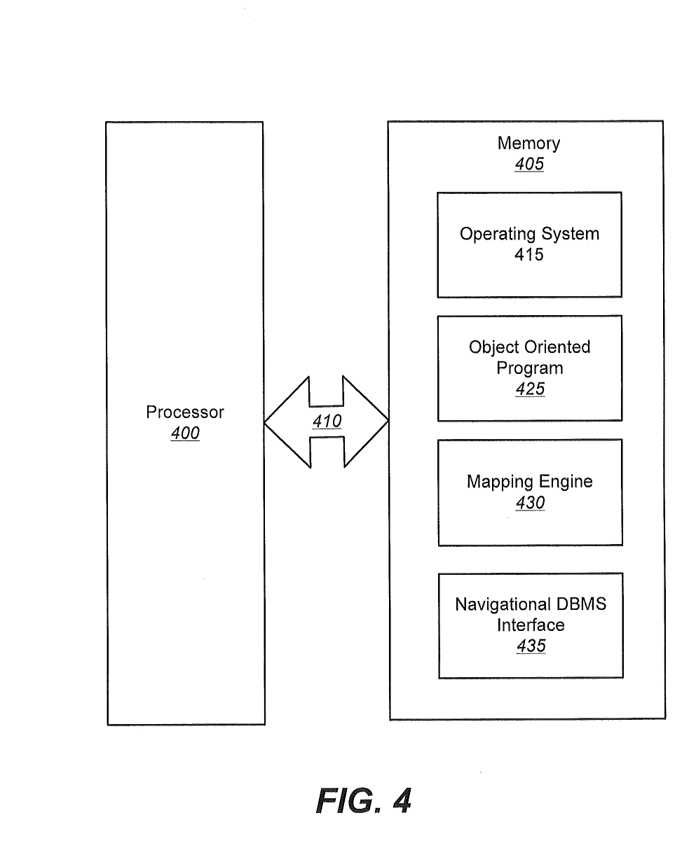

FIG. 4 illustrates a processor 400 and memory 405 that may be used in embodiments of data processing systems, such as the object oriented program 205, mapping engine 210, and navigational database management system interface 215 of FIG. 2 and the data processing system 300 of FIG. 3, respectively, for translating a change in a transient data object of an object oriented computer program into a command for a navigational database system as described above. The processor 400 communicates with the memory 405 via an address/data bus 410. The processor 400 may be, for example, a commercially available or custom microprocessor. The memory 405 is representative of the one or more memory devices containing the software and data used for evaluating a computer program to determine any required data processing facilities for executing the computer program and also for evaluating whether the computer program is compatible with one or more target data processing systems for execution based on what data processing facilities they have installed in accordance with some embodiments of the inventive subject matter. The memory 405 may include, but is not limited to, the following types of devices: cache, ROM, PROM, EPROM, EEPROM, flash, SRAM, and DRAM.

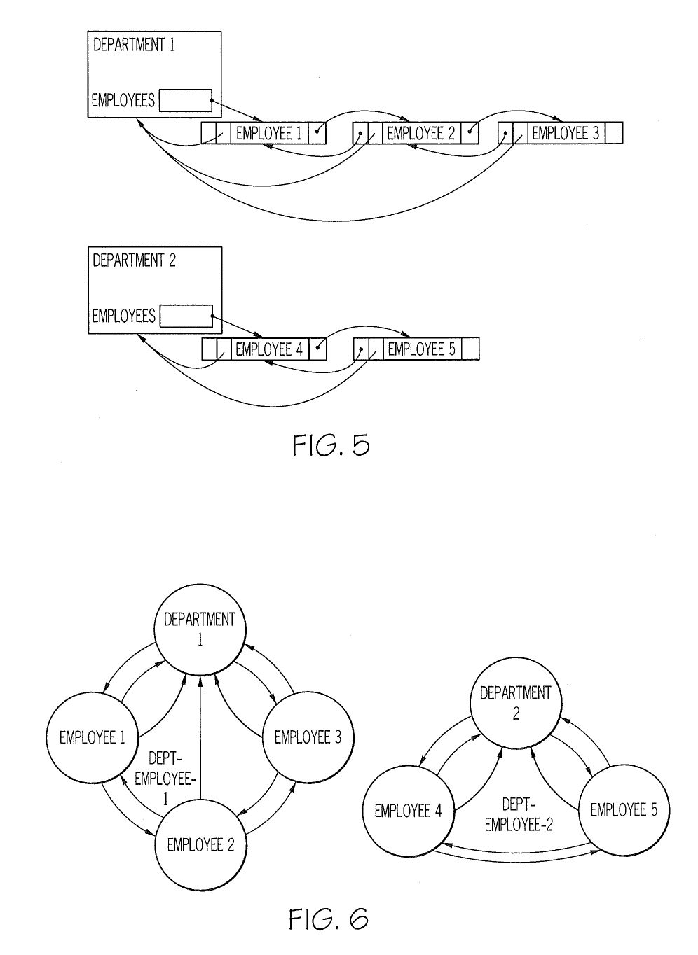

As shown in FIG. 4, the memory 405 may contain up to four or more categories of software and/or data: an operating system 415, an object oriented program module 425, a mapping engine module 430, and a navigational database management interface module 435. The operating system 415 generally controls the operation of the data processing system. In particular, the operating system 415 may manage the data processing system's software and/or hardware resources and may coordinate execution of programs by the processor 400. The object oriented program module 425 may comprise object oriented software that is configured to use object instances to model data. FIG. 5 illustrates relationships between entities or data objects represented in an object oriented model according to some embodiments of the inventive subject matter. The example of FIG. 5 models two departments having employees associated therewith. Employees 1-3 are associated with Department 1 and employees 4 and 5 are associated with Department 2. The object model uses pointers to model the relationships between the entities: a Next pointer is used to point to the next item in the structure, a Prior pointer is used to point to the previous item in the structure, and an Owner pointer is used to point back to the parent item of the structure.

The mapping engine module 430 may be configured to automatically translate changes in the transient data objects used by the object oriented program 425 to model data into commands for a navigational database management system. The mapping engine module 430 may make use of similarities between an objected oriented data model and a navigational database model. FIG. 6 illustrates relationships between entities represented in navigational database model according to some embodiments of the inventive subject matter. The example of FIG. 6 models the same two departments having employees associated therewith as was modeled using the object oriented schema of FIG. 5. The navigational database model uses the same pointers used in the object model of FIG. 5, Because a similar set of pointers are used in defining relationships between entities when modeling data in both the object model and the navigational model, the mapping engine 430 may translate changes in a transient data object during program runtime into an equivalent command for a navigational database management system.

The navigational database management system interface module 435 may be configured to provide an interface for the mapping engine 430 to use when storing and retrieving data in a navigational database management system.

Although FIG. 4 illustrates exemplary hardware/software architectures that may be used in data processing systems, such as the object oriented program 205, mapping engine 210, and navigational database management system interface 215 of FIG. 2 and the data processing system 300 of FIG. 3, respectively, for translating a change in a transient data object of an object oriented computer program into a command for a navigational database system, it will be understood that embodiments of the present invention are not limited to such a configuration but are intended to encompass any configuration capable of carrying out operations described herein. Moreover, the functionality of the object oriented program 205, mapping engine 210, and navigational database management system interface 215 of FIG. 2, the data processing system 300 of FIG. 3, and the hardware/software architecture of FIG. 4 may be implemented as a single processor system, a multi-processor system, a multi-core processor system, or even a network of stand-alone computer systems, in accordance with various embodiments.

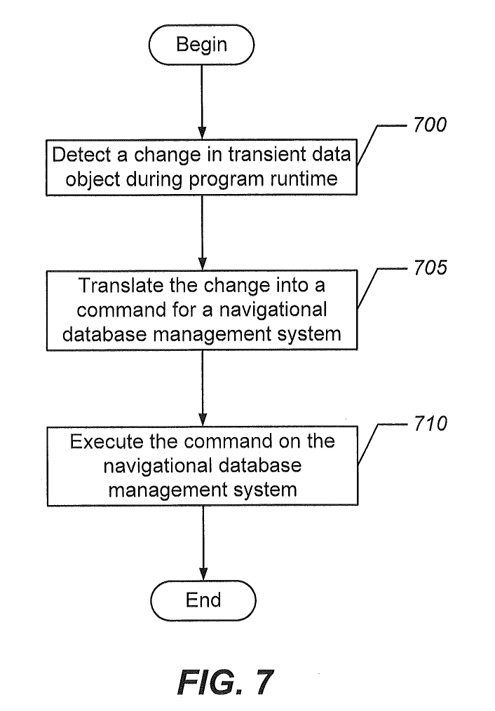

FIG. 7 is a flowchart that illustrates exemplary operations for translating a change in a transient data object of an object oriented computer program into a command for a navigational database system according to some embodiments of the inventive subject matter. Operations begin at block 700 where the mapping engine module 430 detects a change in a transient data object of an object oriented program 425 during program runtime. The mapping engine module 430 translates the change into a command for a navigational database management system at block 705 that can be accessed, for example, through a navigational database management system interface module 435. The command is then executed on the navigational database management system at block 710 to, for example, write or retrieve data therefrom.

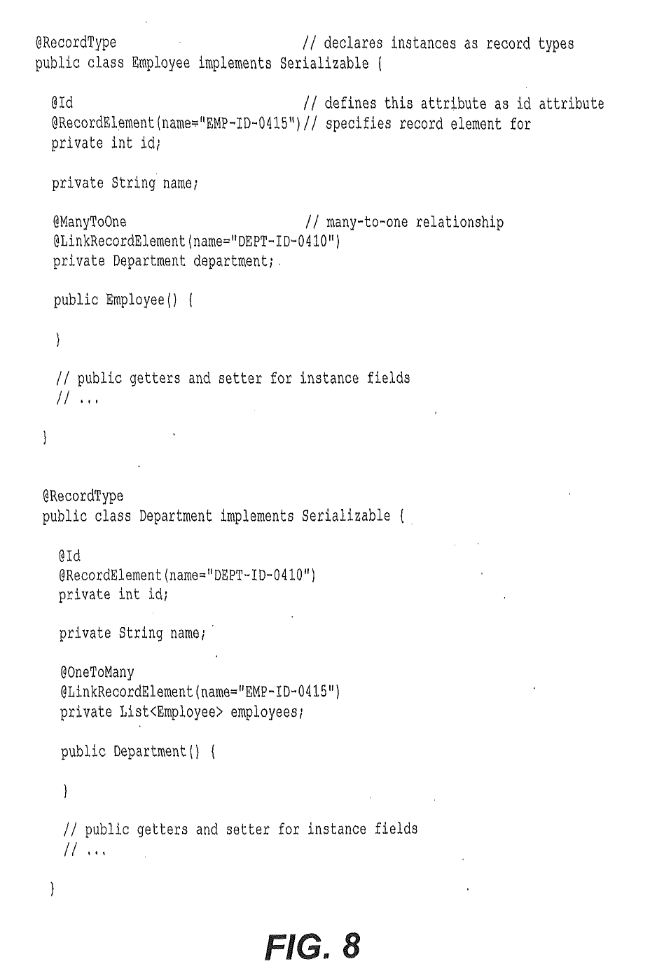

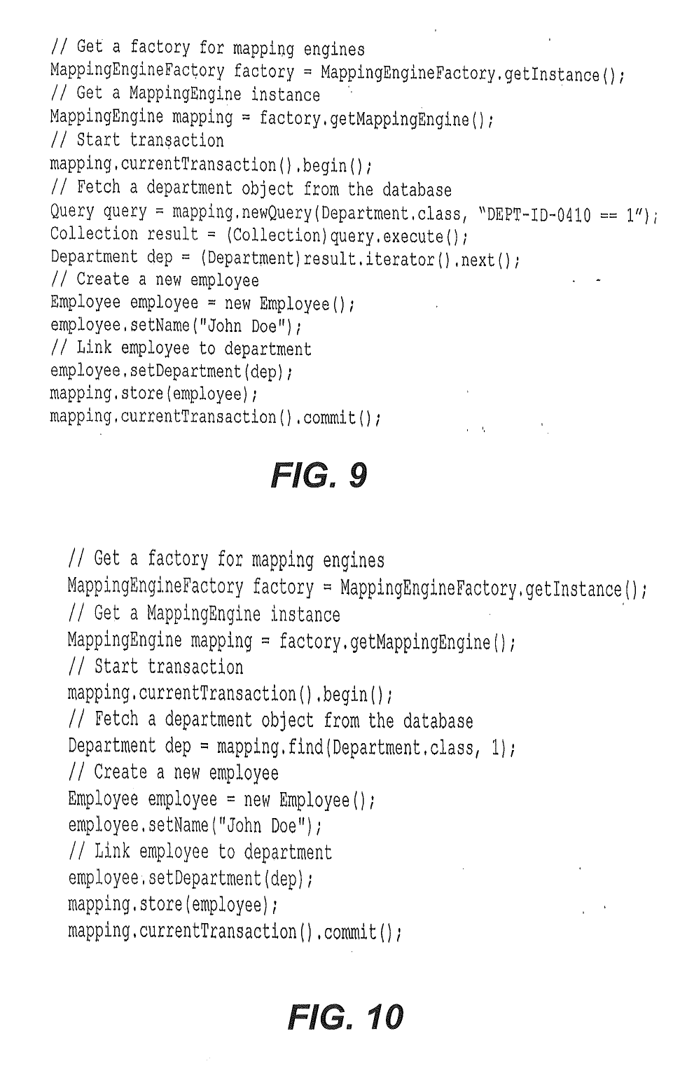

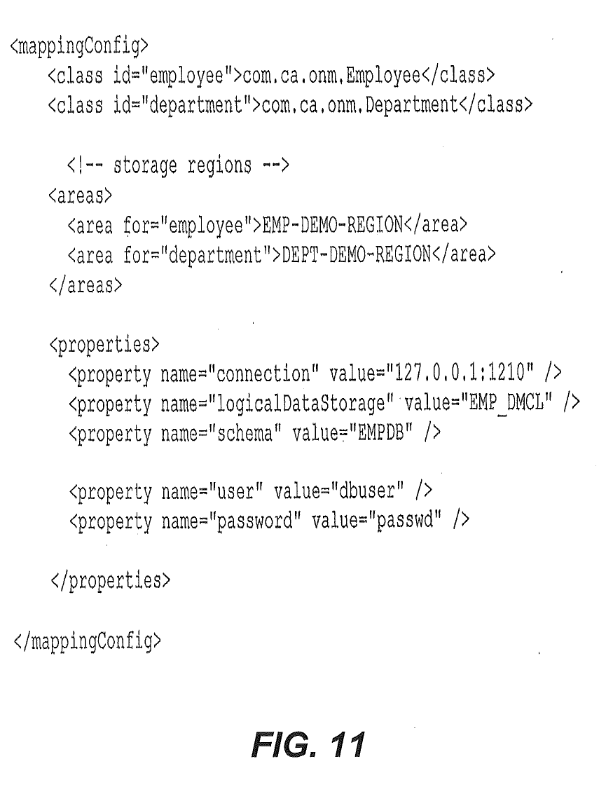

FIGS. 8-11 are pseudo code examples that illustrate operations of the mapping engine 430 according to some embodiments of the inventive subject matter. FIG. 8 illustrates object definitions for an Employee and Department in accordance with the example entity relationships described above with respect to FIGS. 5 and 6. FIG. 9 illustrates pseudo code for performing a data manipulation, such as creating a new employee and linking the new employee to a department, using a query operation. FIG. 10 illustrates pseudo code for performing a data manipulation, such as creating a new employee and linking the new employee to a department using methods defined in the mapping engine module 430. FIG. 11 illustrates pseudo code for providing meta-data for the object oriented program 425 to use to access data or information from the navigational database management system.

In accordance with some embodiments of the inventive subject matter, because the object database model and the navigational database model may use different data types, a conversion may need to take place by converting the data types of one model into types that are compatible with the other model. For each data type in one of the two database models that is incompatible with the other one of the two database models a rule may be defined for converting the incompatible data type to a data type that is compatible. Thus, a set of conversion rules may be defined to ensure that all data is converted without any information loss. Conversion may be bi-directionally unambiguous, such that there is one possible way of conversion. A conversion of a data type from one model into another and then back to the first model should result in the same type and value as it was prior to the conversions. The conversion rule(s) may be applied, for example, when writing and/or reading data from the navigational database management system.

Object data models support the concept of inheritance between object types, whereas navigational data models do not support the concept of inheritance. According to some embodiments of the inventive subject matter, an additional attribute may be added to a navigational model record type to identify the inheritance hierarchy. By using this additional information, the mapping engine 210 may reconstruct an object according to the type inheritance hierarchy. In other embodiments, a separate navigational model record type for each inherited object type may be created to identify the inheritance hierarchy.

The embodiments of methods, systems, and computer program products described herein may provide the ability to store, retrieve, and update transient data objects from program runtime into more permanent data or information storage based on a navigational database management system without the need to explicitly design, create, maintain, and/or synchronize two isolated data models—one for transient program runtime and another for more permanent data or information storage. Mapping the object data model into a navigational database model may enable a programmer to use a navigational database transparently in an object oriented programming language. Thus, a software developer can utilize a navigational database management system without any need of explicit data transformation and work with the object data model only.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

That which is claimed:

1. A method, comprising:
performing operations as follows on a processor:
detecting a change in a transient data object of an object oriented program during program runtime;
translating the change into a command for a navigational database management system; and
executing the command on the navigational database management system.

2. The method of claim 1, wherein the change comprises a creation of a new data object instance.

3. The method of claim 2, wherein executing the command comprises retrieving data from the navigational database management system; and
wherein creation of the new data object instance comprises creation of the new data object instance based on the data that was retrieved from the navigational database management system.

4. The method of claim 1, wherein the change comprises the destruction of an existing data object instance.

5. The method of claim 1, wherein the change comprises a modification of an attribute of an existing data object.

6. The method of claim 1, wherein the navigational database management system is a network model navigational database management system.

7. The method of claim 1, wherein the navigational database management system is a hierarchical database model navigational database management system.

8. The method of claim 1, further comprising:
defining a rule for converting between a data type used in the transient data object of the object oriented program and a data type used in the navigational database management system;
wherein executing the command on the navigational database management system comprises:
applying the rule when writing data to the navigational database management system; and
applying the rule when reading data from the navigational database management system.

9. The method of claim 1, further comprising:
adding an additional attribute to a navigational model record type for a first transient data object, the additional attribute corresponding to a second transient data object that inherits from the first transient data object.

10. The method of claim 1, further comprising:
creating a separate navigational model record type for a first transient data object that inherits from a second transient data object.

11. A system, comprising:
a processor; and
a memory coupled to the processor and comprising computer readable program code embodied in the memory that when executed by the processor causes the processor to perform operations comprising:
detecting a change in a transient data object of an object oriented program during program runtime;
translating the change into a command for a navigational database management system; and
executing the command on the navigational database management system.

12. The system of claim 11, wherein the change comprises a creation of a new data object instance.

13. The system of claim 12, wherein executing the command comprises retrieving data from the navigational database management system; and
wherein creation of the new data object instance comprises creation of the new data object instance based on the data that was retrieved from the navigational database management system.

14. The system of claim 11, wherein the change comprises the destruction of an existing data object instance.

15. The system of claim 11, wherein the change comprises a modification of an attribute of an existing data object.

16. The system of claim 11, wherein the navigational database management system is a network model navigational database management system.

17. The system of claim 11, wherein the navigational database management system is a hierarchical database model navigational database management system.

18. The system of claim 11, wherein the operations further comprise:
defining a rule for converting between a data type used in the transient data object of the object oriented program and a data type used in the navigational database management system;
executing the command on the navigational database management system comprises:
applying the rule when writing data to the navigational database management system; and
applying the rule when reading data from the navigational database management system.

19. The system of claim 11, wherein the operations further comprise:
adding an additional attribute to a navigational model record type for a first transient data object, the additional attribute corresponding to a second transient data object that inherits from the first transient data object.

20. The system of claim 11, wherein the operations further comprise:
creating a separate navigational model record type for a first transient data object that inherits from a second transient data object.

21. A computer program product, comprising:
a tangible computer readable storage medium comprising computer readable program code embodied in the medium that when executed by a processor causes the processor to perform operations comprising:
detecting a change in a transient data object of an object oriented program during program runtime;
translating the change into a command for a navigational database management system; and
executing the command on the navigational database management system.

22. The computer program product of claim 21, wherein the change comprises a creation of a new data object instance.

23. The computer program product of claim 22, wherein executing the command comprises retrieving data from the navigational database management system; and
wherein creation of the new data object instance comprises creation of the new data object instance based on the data that was retrieved from the navigational database management system.

24. The computer program product of claim 21, wherein the change comprises the destruction of an existing data object instance.

25. The computer program product of claim 21, wherein the change comprises a modification of an attribute of an existing data object.

26. The computer program product of claim 21, wherein the navigational database management system is a network model navigational database management system.

27. The computer program product of claim 21, wherein the navigational database management system is a hierarchical database model navigational database management system.

28. The computer program product of claim 21, wherein the operations further comprise:
defining a rule for converting between a data type used in the transient data object of the object oriented program and a data type used in the navigational database management system;
executing the command on the navigational database management system comprises:
applying the rule when writing data to the navigational database management system; and
applying the rule when reading data from the navigational database management system.

29. The computer program product of claim 21, wherein the operations further comprise:
adding an additional attribute to a navigational model record type for a first transient data object, the additional attribute corresponding to a second transient data object that inherits from the first transient data object.

30. The computer program product of claim 21, wherein the operations further comprise:
creating a separate navigational model record type for a first transient data object that inherits from a second transient data object.
